(19) United States
(12) Patent Application Publication
(10) Pub. No.: US 2002/0140133 A1
(43) Pub. Date: Oct. 3, 2002

(54) Bichromal sphere fabrication

(76) Inventor: Chad Byron Moore, Corning, NY (US)

Correspondence Address: BROWN & MICHAELS, PC, 400 M & T BANK BUILDING, 118 NORTH TIOGA ST, ITHACA, NY, 14850, US

(21) Appl. No.: 10/109,222

(22) Filed: Mar. 28, 2002

Related U.S. Application Data
(60) Provisional application No. 60/279,964, filed on Mar. 29, 2001.

(51) Int. Cl. B29C 35/08

(52) U.S. Cl. 264/400; 264/141; 264/143

(57) ABSTRACT

The invention discloses different methods of creating bichromal spheres and cylinders by using both printing techniques and creating a sheet or fiber of the bichromal material and cutting the sheet or fiber into small sizes. To create spheres the small particles are heated to a point where their surface tension creates bichromal spheres. The bichromal fiber can be created by drawing the fiber from a bichromal preform or the bichromal fiber can be formed using a pulltrusion process, where a large bichromal fiber is extruded and is drawn down as it exits the extruded. Coating the bichromal fiber with a coating during the fiber draw process or before the fiber is cut into shorter lengths can create microencapsulated cylinders or spheres.

### BACKGROUND OF THE INVENTION

1. Field of the Invention

The invention pertains to the field of reflective displays and methods of manufacture. More particularly, the invention pertains to the manufacture of bichromal spheres for use in a twisting ball electro-optic medium.

2. Description of Related Art

A reflective bistable electro-optic display using twisting bichromal spheres or Gyricon™ material was invented by N. Sheridon at Xerox, U.S. Pat. No. 4,126,854 “Twisting Ball Display”. It was initially called a twisting ball display because it was composed of small spheres, one side coated black the other white, sandwiched between to electroded glass plates. Upon applying an electric field the spheres with a positive charged white half and relative negative charged black half can be addressed (rotated), as shown in FIG. 1. Since this invention several methods of fabricating the bichromal spheres have been disclosed, U.S. Pat. Nos. 4,143,103, 5,262,098, 5,344,594, 5,739,801, 5,900,192, 5,904,790, 5,922,268. Most of these bichromal ball-making applications use centrifugal force to create a ball where two different colored materials are added to two sides of a spinning structure to create the bichromal spheres. Although these techniques are useful for creating bichromal spheres in large volumes, such as needed for electronic paper, they tend to create spheres that have a large distribution in size and are somewhat limited to making two colored spheres (black on one half and white on the other half).

### SUMMARY OF THE INVENTION

The present invention describes a method of creating bichromal spheres that result in a tight distribution in ball size and a range in bichromal structures, which is more suitable for display applications. The invention is to create a sheet or fiber of the bichromal material and cut the sheet or fiber into small sizes. To create spheres the small particles are heated to a point where their surface tension creates bichromal spheres. The bichromal material sheets can be fabricated by applying two dissimilar materials together, such as a white and black sheet/film or by adding at least one film between two sheets. The bichromal fiber can be created by drawing the fiber from a bichromal preform or the bichromal fiber can be formed using a pulltrusion process, where a large bichromal fiber is extruded and is drawn down as it exits the extruded. Coating the bichromal fiber with a coating during the fiber draw process or before the fiber is cut into shorter lengths can create microencapsulated cylinders or spheres.

A printing technique can be used to create bichromal pieces that can be subsequently turned into bichromal spheres. The bichromal pieces can be created by collecting two different color materials on the heads of pins on a drum and removing the bichromal pieces and spherodizing them. The bichromal pieces could also be created by printing the two layers on a plate and removing and spherodizing the bichromal pieces. Several different methods could be used to apply the bichromal materials to the plate, such as; transfer printing, inkjet printing, direct printing from a fine point (like touching a fiber to a hot surface and having part of the fiber transferred to the surface), charge transfer (such as laser printing), silkscreening, photolithograph, or printing or extruding through a shadow mask or die.

The sheet or fiber can be mechanically cut or cut using a laser. Since the small cut bichromal pieces are typically created from a polymeric material, heat can be added to them to spherodize them into bichromal spheres. Heat can be added using a laser while or after cutting, or by dropping them through a furnace, or by placing them in a hot liquid bath.

In addition to bichromal spheres, bichromal cylinders can be created by cutting the bichromal fiber into short lengths. Multichromal cylinders and spheres can also be created by combining more than two colors per cylinder or sphere.

### BRIEF DESCRIPTION OF THE DRAWING

FIG. 1 schematically shows a cross-section and addressing of a Gyricon™ display in accordance with the prior art.

FIG. 2 show the cut lines in a sheet of bichromal material to produce small bichromal particles.

FIG. 3A schematically show a small bichromal particle from the cut sheet in FIG. 2.

FIG. 3B schematically shows a top view of a spherodized particle from FIG. 3A assuming the top and bottom sheet thickness' form perfect hemispheres.

FIG. 3C schematically shows a top view of a spherodized particle from FIG. 3A assuming the top and bottom sheet thickness' are a little thicker than the width and depth of the cut pieces.

FIG. 3D schematically shows a top view of a spherodized particle from FIG. 3A assuming the top and bottom sheet thickness' are a lot thicker than the width and depth of the cut pieces.

FIG. 4A schematically shows a cross-section of the sheet in FIG. 2 comprising of a black absorbing sheet fused to a white reflecting sheet.

FIG. 4B schematically shows a cross-section of the sheet in FIG. 2 comprising of two clear sheets sandwiching a black absorbing film.

FIG. 4C schematically shows a cross-section of the sheet in FIG. 2 comprising of a clear sheet and a white reflecting sheet sandwiching a black absorbing film.

FIG. 4D schematically shows a cross-section of the sheet in FIG. 2 comprising two clear sheets sandwiching a reflecting film.

FIG. 4E schematically shows a cross-section of the sheet in FIG. 2 comprising of a black absorbing sheet and a clear sheet sandwiching a reflecting film.

FIG. 4F schematically shows a cross-section of the sheet in FIG. 2 comprising of two clear sheets sandwiching a black absorbing film and a reflecting film.

FIG. 4G schematically shows a cross-section of the sheet in FIG. 2 comprising of two clear sheets sandwiching a black absorbing film and a colored reflecting film.

FIG. 5 schematically shows the process of drawing bichromal fiber from a bichromal preform, cutting the bichromal fiber with a laser and spherodizing the cut pieces as they fall through a furnace.

FIG. 6 schematically shows the process of pulling bichromal fiber while extruding it through a die, cutting the bichromal fiber with a knife cutter and spherodizing the cut pieces as they fall through a furnace.

FIG. 7 schematically shows the process of drawing bichromal fiber from a bichromal preform and flowing hot fluid past the end of the fiber to pull small bichromal spheres off the end of the fiber.

FIG. 8 schematically shows the process of drawing bichromal fiber from a bichromal preform and pulling the fiber through a die to apply a coating that is used to form microencapsulated bichromal cylinders.

FIG. 9A schematically shows the process of applying one of the two bichromal materials to the surface of pins attached to a rotating drum.

FIG. 9B schematically shows the process of applying a second chromal material on top of a first chromal material on the rotating drum.

FIG. 9C schematically shows the process of removing the bichromal pieces from the drum pins and spherodizing them into bichromal spheres.

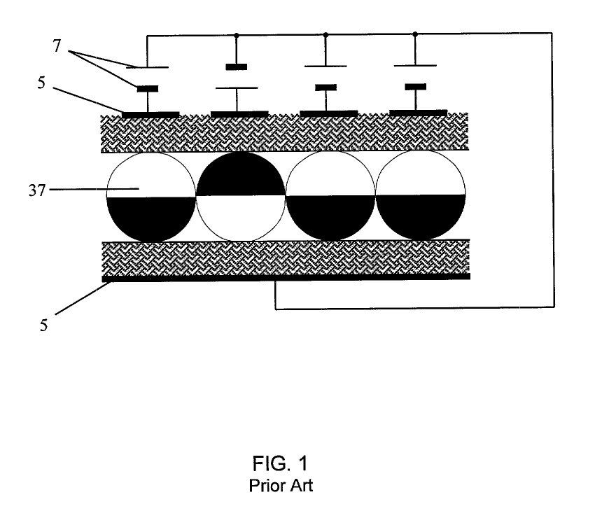

### DETAILED DESCRIPTION OF THE INVENTION

The invention is to create a sheet or fiber of the bichromal material and cut the sheet or fiber into small well defined sizes then spherodize the small particles to create bichromal spheres. The bichromal material sheets can be fabricated by applying two dissimilar materials together, such as a white and black sheet/film or by adding at least one film between two sheets. The bichromal fiber can be created by drawing the fiber from a bichromal preform or extruding the fiber directly from/through a die. The bichromal fiber can also be formed using a pulltrusion process, where a large bichromal fiber is extruded and is redrawn as it exits the extruder or soon after in a fiber draw process. The sheet or fiber can be mechanically cut or cut using a laser. Since the small cut bichromal pieces are typically created from a polymeric material, heat can be added to them to spherodize them into bichromal spheres. Heat can be added using a laser while or after cutting, or by dropping them through a furnace, or by placing them in a hot liquid bath. In addition to bichromal spheres, bichromal cylinders can be created by cutting the bichromal fiber into short lengths.

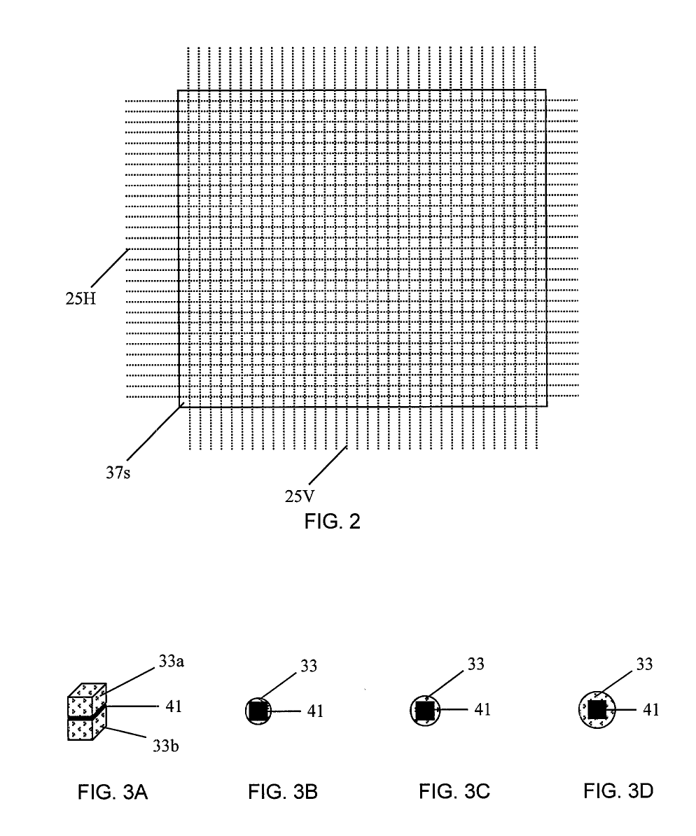

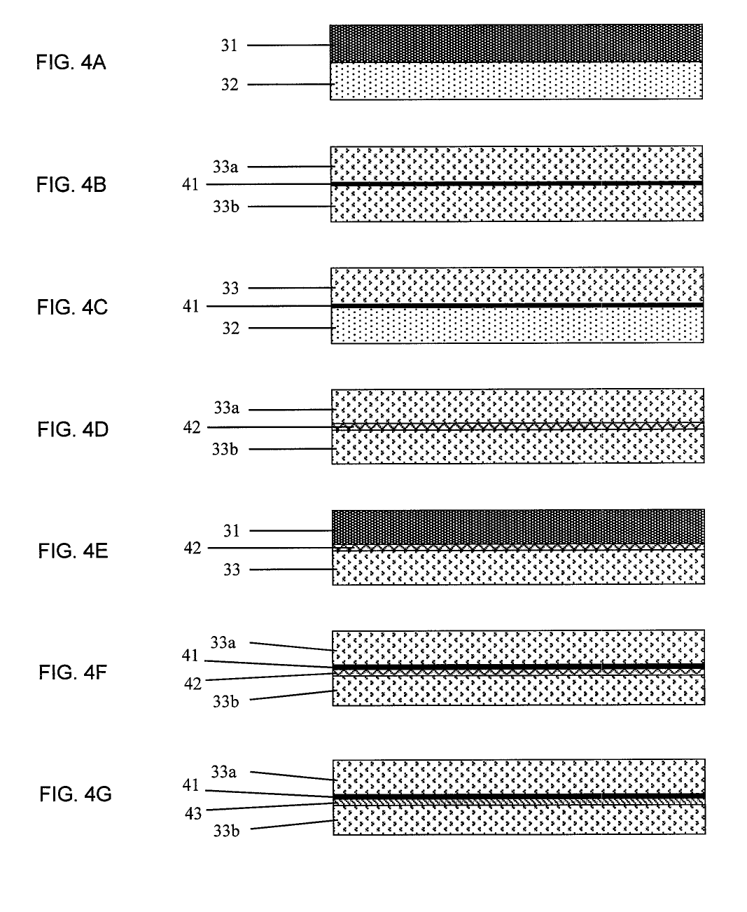

FIG. 2 illustrates two orthogonal arrays of cut lines (25V and 25H) in a bichromal sheet 37s of material. Several possible cross-sections of this sheet are shown in FIG. 4. The bichromal sheet 37s can be cut along the cut lines (25V and 25H) using a sharp mechanical cutter, such as a razor blade, or cut using a laser. If a laser is used it would need to be focused to a fine point to reduce waste and heating of the nearby regions in the sheet 37s. The sheet could also be created by an array of fibers. Using an array of fibers would only require the sheet to be cut in one dimension. Cutting an array of fibers that form a sheet would be the easiest method of creating short bichromal cylinders.

FIG. 3A depicts one piece cut from the sheet 37s in FIG. 2. The initial sheet was formed by sandwiching two clear polymer sheets 33a and 33b around a black film 41. This cut bichromal piece can then be spherodized to form a bichromal sphere. The simplest method of spherodizing the bichromal pieces would be to place them in a hot oil bath. The heat from the oil will cause the polymer 33a and 33b to soften and surface tension will cause the bichromal piece to turn into a sphere. The oil will also serve to keep the pieces from sticking together. Assuming the initial bichromal sheet 37s was constructed as shown in FIG. 3A with a black film 41 in the center and this black film does not soften during the spherodizing process. Then upon heating the two clear polymer films 33a and 33b surrounding the black film 41 will create the two hemispheres of the balls. The thickness of each of the two sheets 33a and 33b that form the bichromal material 37s will determine the final ball size and appearance of the bichromal sphere. If the volume of materials 33a and 33b are such than they form perfect hemispheres around the black film 41 then the bichromal balls will have an appearance normal to the black film 41, as shown in FIG. 3B. If there is a little more material in the top 33a and bottom 33b clear polymer sheet then the black film 41 will be totally contained within the balls, as shown in FIG. 3C. Using very thick clear polymer sheets 33a and 33b will create a ball with a small square black patch in the center of a large clear ball, as shown in FIG. 3D. Any ratio of material thickness could be chosen depending on the application, appearance and addressability of the bichromal twisting ball material. Note that this process could be used for many of the different bichromal sheet materials shown in FIG. 4.

The operation of the bichromal spheres shown in FIGS. 3B-3D would create and image that is black when the spheres are rotated such that the black film is normal to the viewer and clear when the surface is rotated 90° from the viewer. This addressing operation would require electrodes above, below and on the sides of the twisting ball material, as discussed in U.S. patent application Ser. No. 09/517,759 “Reflective Electro-Optic Fiber-Based Displays”, which is incorporated herein by reference.

FIGS. 4A-4G show different cross-sections of the starting bichromal sheet to be cut and spherodized into balls as discussed above. FIG. 4A shows a bichromal sheet formed by fusing a black absorbing sheet 31 to a white reflective sheet 32. Therefore, when bichromal spheres of this material is formed they will be black on one side 31 of the hemisphere and white, on the other side 32. Note that by changing the relative thickness of the two sheets will create non-symmetrical bichromal spheres; balls that have more white than black or black than white. FIG. 4B represents a black absorbing film 41 sandwiched between two clear polymer sheets 33a and 33b, similar to that shown in FIG. 3. In order for bichromal spheres to be addressed/rotated in an electric field the two clear polymer materials 33a and 33b should be composed of different materials that support different zeta potentials when placed in a liquid solution used to set-up the charge on the surface of the spheres. FIG. 4C represents a black absorbing film 41 sandwiched between a clear polymer sheet 33 and a white reflective polymer sheet 32. This type of bichromal material would create spheres with a wide white viewing angle and only truly appear black when fully addressed and viewed normal to the display. FIG. 4D represents a reflective material 42 sandwiched between two clear polymer materials 33a and 33b. Bichromal spheres created using this material should be addressed similar to those spheres created from the material shown in FIG. 4B, except when the spheres are rotated such that the film 42 is normal to the viewer the display would appear reflective. FIG. 4E represents a reflective film 42 sandwiched between a black absorbing sheet 31 and a clear polymer sheet 33. Bichromal spheres created from this material would create a display with very high contrast. The display would appear black at a large viewing angle until the spheres are rotated almost all the way around to the point of the reflective film 42 being normal the viewer, where it would then appear reflective. FIG. 4F represents a black absorbing film 41 and a reflecting film 42 sandwiched between two clear sheets 33a and 33b. The sandwiched sheets containing the films (41 and/or 42) could be formed by coating one or both to the polymer sheets with a film then fusing the films together. The black absorbing film 41 could be a carbon coating that is formed using a physical vapor deposition process or could simply be formed by coating one of the polymer sheets with carbon black powder. The reflective film 42 could be formed by depositing a reflective metal film, such as aluminum, chromium, etc., on the surface of a polymer sheet using many different physical vapor deposition techniques or plasma arc spraying. Bichromal color sphere could also be created by replacing the black 31 or white 32 material to form the spheres with a colored reflecting or color absorbing materials. FIG. 4G represents another method of adding color 43 as a thin sheet in the center of the sphere. This color 43 could be added as a reflecting colored material to create a black appearance on one side and a red, green or blue appearance on the other side depending on the color of the reflecting film chosen. The colored film 43 could also serve as a colored absorbing film to create colored bichromal spheres.

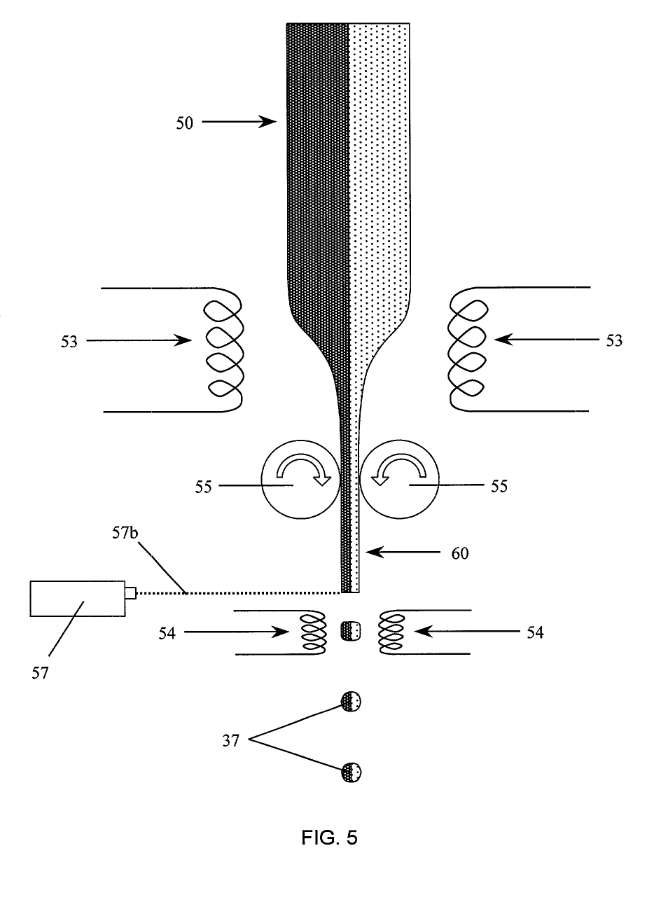

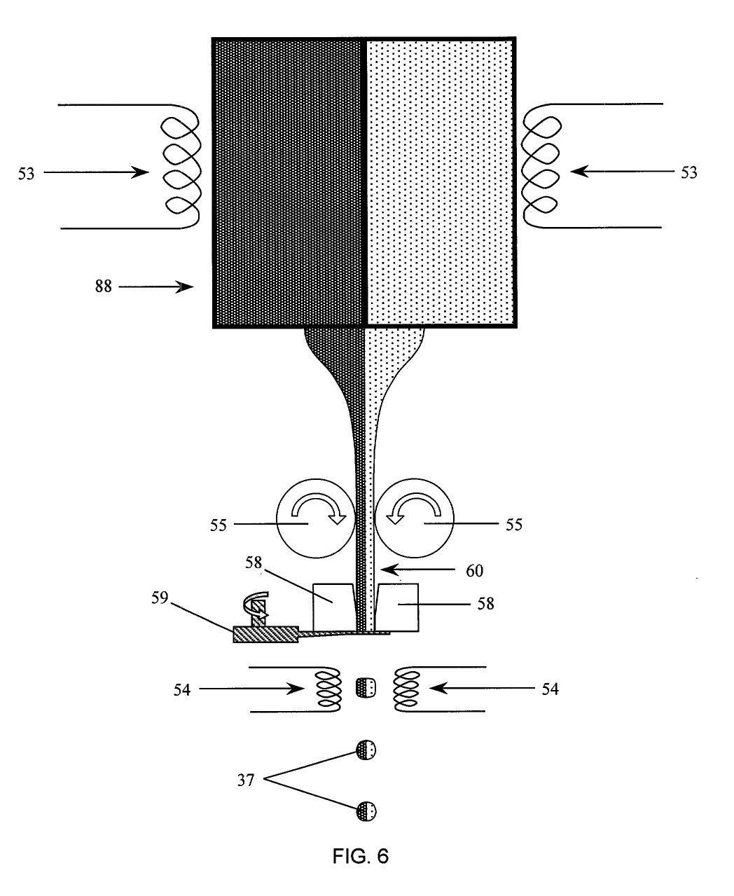

FIG. 5 depicts a method of drawing bichromal fiber 60 and periodically cutting the fiber using a laser 57 into short sections. The short sections then fall through a furnace 54 where they are spherodized into bichromal spheres 37. To create the fiber a large bichromal preform 50 is feed into a furnace 53 where it is elongated and reduced in cross-section using a fiber drawing mechanism 55, such as pinch rollers or a tractor draw. As the bichromal fiber 60 exits the draw mechanism 55 a laser beam 57b cuts the fiber into short pieces. By choosing the proper laser beam 57b profile and power the bichromal pieces 37 can be spherodized as they are cut, thus not requiring any subsequent heating steps to make them round. This laser cutting and spherodizing may require more than one laser, a finely focused laser beam 57b to cut the fiber 60 and a second laser to add the heat to spherodize it. Another method of cutting the bichromal fiber 60 is shown in FIG. 6. This example using a rotating knife blade 59 to cut the fiber 60 into small pieces that can be spherodized. However, if the bichromal fiber 60 is mechanically cut a fiber guide 58 will be required to add resistance during the cutting process.

A continuous strand of bichromal fiber 60 can be created in many different ways. FIG. 6 shows one method where pulltrusion is used to form a fiber directly from the two molten materials. Bichromal fiber 60 is formed by extruding material out of a furnace 88 through a die and using the heat from the extruded material to immediately draw it down into fiber 60, similar to how fiberglass is formed. Another method is by pulling the fiber 60 directly from “two furnaces” through a die. In this case the two bichromal materials would be feed into the die where they would fuse and be pulled out of the die as a single continuous fiber 60.

Another method of forming addressable bichromal material is to cut the bichromal material into small cylinders or elongated spheres. If a laser is used to cut the bichromal fiber 60 the ends of the small cylinders will already be rounded by the heat from the laser allowing them to stack and rotate in a display. However, small cylinders will only have one degree of rotational freedom making them more difficult to assemble in a sheet than bichromal spheres.

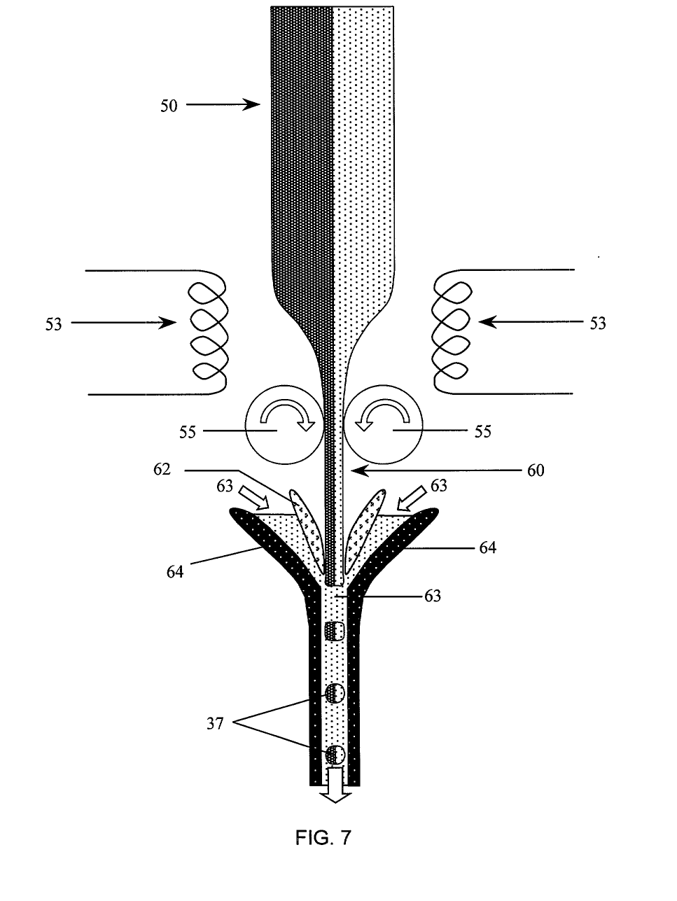

FIG. 7 shows another method of forming bichromal spheres or bichromal cylinders from a continuously drawn bichromal fiber 60. As the bichromal fiber 60 is drawn from a preform 50, it is threaded through a fiber guide 62. As the bichromal fiber 60 exits the fiber guide 62 is comes into contact with a hot fluid 63 that is flowing across the end of the exiting bichromal fiber 60. The hot fluid 63 softens the end of the bichromal fiber 60 and pulls small sections of the end of the bichromal fiber 60. As the hot fluid 63 flows down the tube guides 64 it spherodizes the small section into a bichromal sphere 37. The diameter of the sphere will be controlled by the initial size of the bichromal fiber 60, the feed rate of the bichromal fiber 60, the temperature of the hot fluid 63, and the velocity of the hot fluid 63 flow.

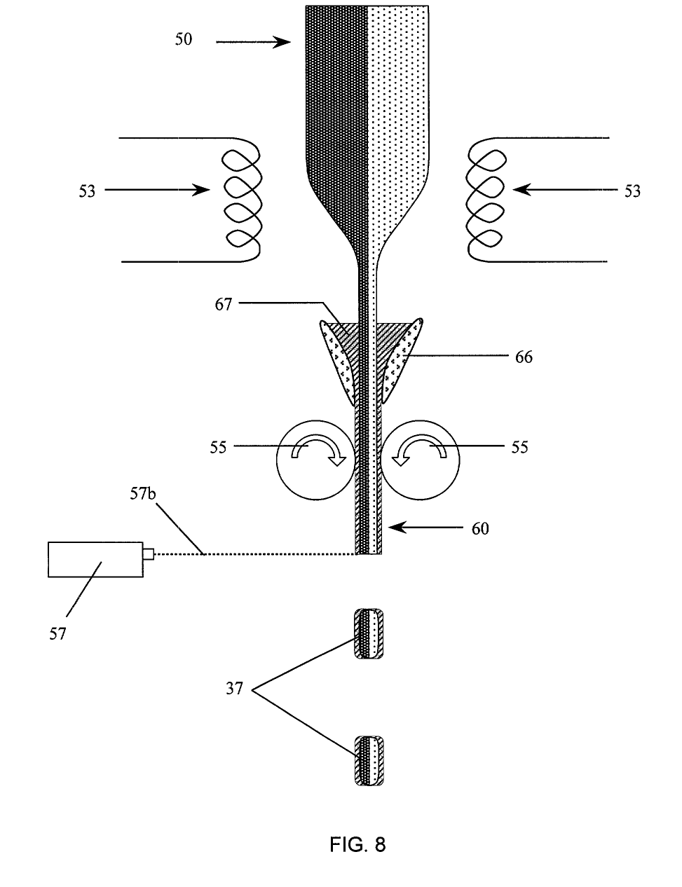

FIG. 8 shows a method of creating microencapsulated bichromal cylinders or spheres 37. A film is coated on the bichromal fiber 60 by pulling the fiber through a die 66 containing the material 67 to create the film coating. The film material 67 could be applied to the fiber 60 using other techniques, such as spraying or dipping or could be included in the initial preform 50. One of the steps in the process of creating an electro-optic material is to place the spheres or cylinders in a liquid that tend to swell the microencapsulated film 67, which creates a small fluid filled sack around the sphere or cylinder and allows it to spin freely. The microencapsulated film 67 is used to keep the spheres or cylinders from coming into contact with each other, thus keeping the charge associated with each bichromal sphere or cylinder separate and allowing them to spin freely. Applying the microencapsulated film 67 during the fiber draw process or in a subsequent step before the fiber is cut into spheres or cylinders removes the process step of mixing the spheres or cylinders in a bulk swellable sheet. In addition, bichromal cylinders will be much easier to align when microencapsulated as opposed to being formed in a swellable sheet. The initial fiber can also be composed of more than two different chromal material, thus creating multichromal cylinders or spheres.

Another method of creating bichromal spheres is to use printing techniques to form the volumetric portions of the two halves of the bichromal spheres and then heating them to create a bichromal spherical shape. The two different bichromal materials could be sequentially applied to a drum or sheet consisting of small collector pins. Controlling the process will allow the two bichromal materials to only be deposited on the ends of the collector pins. The bichromal material could then be removed and spherodized to create the bichromal spheres. Several different techniques can be used to remove of the bichromal material, such as, using a release layer, heat from either hot air or hot liquid, or mechanically removing the material. Another printing method would be to print the two bichromal materials on a plate then remove the combined material and spherodize it into a bichromal sphere. Several different methods could be used to apply the bichromal materials to the plate, such as; transfer printing, inkjet printing, direct printing from a fine point (like touching a fiber to a hot surface and having part of the fiber transferred to the surface), charge transfer (such as laser printing), silkscreening, photolithograph, or printing or extruding through a shadow mask or die.

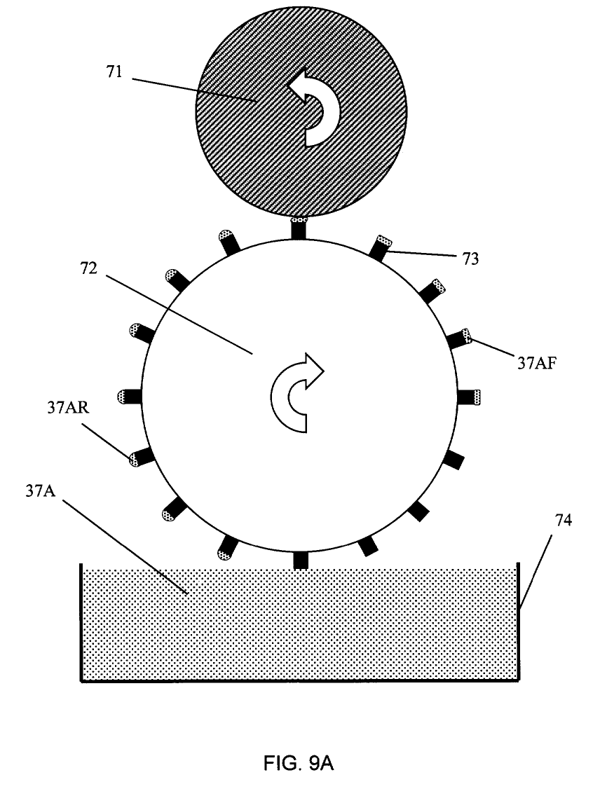

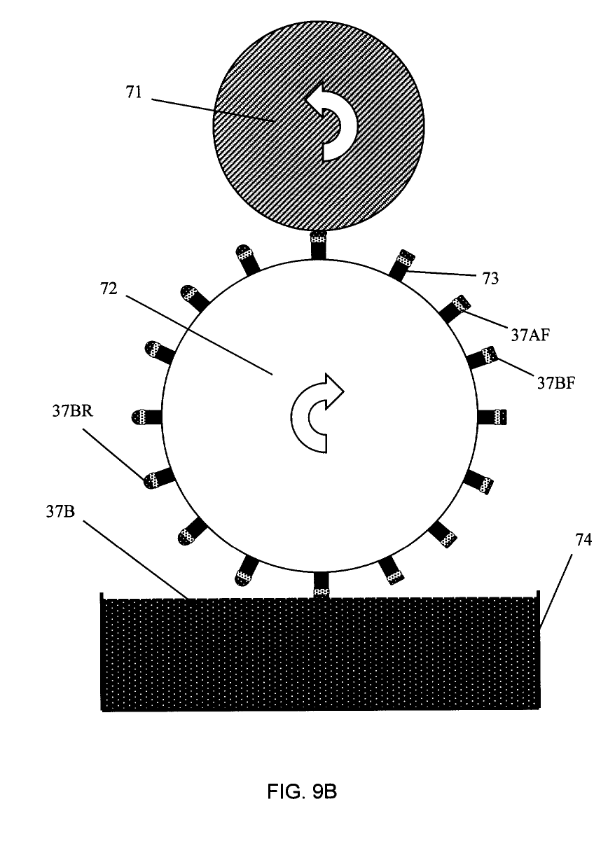

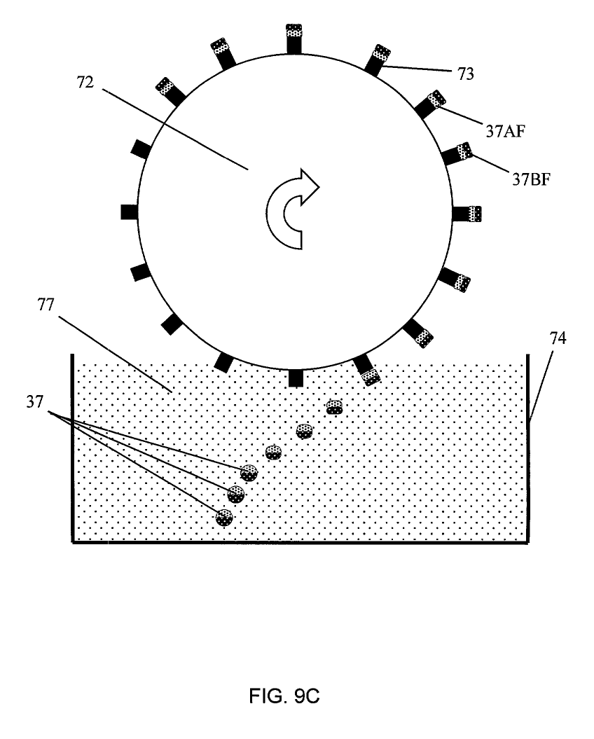

FIG. 9 shows one method of collecting the two bichromal materials (37A and 37B) onto pins 73 on a drum 72 and subsequently removing and spherodizing them to form bichromal spheres. FIG. 9A shows the first bichromal material 37A being collected onto the pins 73 on a drum 72 by rotating the heads of the pins 73 through a tube 74 of molten chromal material 37A. As the heads of the pins 73 exit the molten chromal material 37A solution they collect a small amount of the chromal material on the end of the pins 73. In order to collect the next chromal material 37B the first chromal material 37A is flatten by rolling a second roll 71 across the surface of the chromal material 37AR. This second roll 71 creates a flat surface 37AF to collect the second chromal material 37B, as shown in FIG. 9B. The collection of the second chromal material 37B is similar to the first, but in this case it is shown that several rotations of the first drum 72 through the chromal material 37B is needed to build up the layer thickness. The amount of chromal material (37A or 37B) that will be gathered on the ends of the pins 73 will mainly depend on the viscosity of the chromal material and the surface temperature of the chromal material. FIG. 9C shows one method of removing the bichromal material (37AF and 37BF) by rotating the pins 73 of the drum 72 through a hot liquid 77 that releases it from the pins 73 and surface tension creates a bichromal sphere 37.

In the above examples the term bichromal was used to describe a two color state of a sphere or cylinder. It is to be understood that the term multicolor could be substituted for bichromal and that all the above examples could be constructed using a multicolored sphere or cylinder. Multicolored meaning three or more color states in a sphere or cylinder. An example of a multicolored cylinder would be one where the cylinder is divided into three quadrants like three pieces of a pie when viewed normal to its length. Multicolor cylinders or spheres would yield a pixel capable of displaying more than two different colors.

Accordingly, it is to be understood that the embodiments of the invention herein described are merely illustrative of the application of the principles of the invention. Reference herein to details of the illustrated embodiments is not intended to limit the scope of the claims, which themselves recite those features regarded as essential to the invention.

What is claimed is:

1. A method of making bichromal spheres comprising the steps of
fabricating a sheet or fiber of the bichromal material;
cutting the sheet or fiber into small well defined sizes; and
heating the small well defined sized bichromal material to create a spherical shape.

2. A method in claim 1, wherein said bichromal material is cut using a laser.

3. A method in claim 1, wherein said bichromal material is mechanically cut.

4. A method in claim 1, wherein said fiber is formed by drawing said fiber from a larger preform.

5. A method in claim 1, wherein said fiber is formed by drawing said fiber from a small die containing at least two dissimilar materials.

6. A method in claim 1, wherein said fiber is formed by drawing said fiber down from a larger section that is extruded through a die.

7. A method in claim 1, wherein said sheet is formed by fusing a black and white polymer material together.

8. A method in claim 1, wherein said sheet is formed by sandwiching a black absorbing film between two clear polymer sheets.

9. A method in claim 1, wherein said sheet is formed by sandwiching a black absorbing film between a white polymer sheet and a clear polymer sheet.

10. A method in claim 1, wherein said sheet is formed by sandwiching a reflective film between two clear polymer sheets.

11. A method in claim 1, wherein said sheet is formed by sandwiching a reflective film between a black absorbing sheet and a clear sheet.

12. A method in claim 1, wherein said sheet is formed by sandwiching a black absorbing film and a reflective film between two clear polymer films.

13. A method in claim 1, wherein said sheet consist of a color absorbing material.

14. A method in claim 1, wherein said sheet consist of a color reflecting material.

15. A method in claim 1, wherein said small well defined sized bichromal material is spherodized into balls by placing them in a hot liquid solution.

16. A method in claim 1, wherein said small well defined sized bichromal material is spherodized into balls using a laser during or subsequent to the cutting process step.

17. A method in claim 1, wherein said small well defined sized bichromal material is spherodized into balls by dropping the material through a furnace.

18. A method of creating bichromal spheres comprising the steps of
drawing a bichromal fiber,
feeding the bichromal fiber into a fiber guide,
flowing a hot liquid across the end of the bichromal fiber to force it to be divided into short sections, and
using the heat from the liquid to spherodized the short sections.

19. A method of creating bichromal cylinders comprising the steps of
drawing a bichromal fiber,
feeding the bichromal fiber into a fiber guide, and
flowing a hot liquid across the end of the bichromal fiber to force it to be divided into short sections.

20. A method of creating microencapsulated cylinder comprising the steps of
drawing a fiber,
coating the fiber with a microencapsulating film, and
cutting the microencapsulated fiber into short sections.

21. A method of creating microencapsulated spheres comprising the steps of
drawing a bichromal fiber,
coating the fiber with a microencapsulating film,
cutting the microencapsulated fiber into short sections, and
heating the short sections to create a spherical shape.

22. A method of creating microencapsulated multichromal cylinder comprising the steps of
drawing a multichromal fiber,
coating the multichromal fiber with a microencapsulating film, and.
cutting the microencapsulated multichromal fiber into short sections.

23. A method of creating bichromal spheres comprising the steps of
gathering a first color onto the end of an object,
gathering a second color onto the first color,
removing the two colors from the end of the object, and
heating the two colors to form a spherical shape.

24. A method of creating bichromal spheres comprising the steps of
printing a first color onto a plate,
printing a second color onto the first color,
removing the two colors form the plate, and
heating the two colors to form a spherical shape.

25. A method in claim 24, wherein said printing or colors is preformed using a process selected from the following processes group:
transfer printing,
inkjet printing,
direct printing from a fine point (like touching a fiber to a hot surface and having part of the fiber transferred to the surface),
charge transfer (such as laser printing),
silkscreening,
photolithograph, and
printing or extruding through a shadow mask or die.
